(19) United States
(12) Patent Application Publication
(10) Pub. No.: US 2013/0024497 A1
(43) Pub. Date: Jan. 24, 2013

(54) COMMUNICATION DEVICE MANAGEMENT OVER A TELECOMMUNICATIONS NETWORK

(71) Applicants: Omar Elloumi, Velizy (FR); Jean-Marc Ballot, Nozay (FR)

(72) Inventors: Omar Elloumi, Velizy (FR); Jean-Marc Ballot, Nozay (FR)

(21) Appl. No.: 13/497,292

(22) PCT Filed: Oct. 12, 2010
(86) PCT No.: PCT/EP10/65245

§ 371 Date: Jul. 24, 2012

(30) Foreign Application Priority Data
Oct. 14, 2009 (FR) 0957203

(51) Int. Cl. G06F 15/16

(52) U.S. Cl. 709/203

(57) ABSTRACT

In order to manage at least one communications device (DC) implementing an application that uses a service offered by an application server (SA) over a telecommunications network (RT), the device (DC) comprising application data (DonA) specific to the application and communication data (DonC) related to communication parameters for the operation of the service over the telecommunications network, the communication data (DonC) being managed by a management server (SG), the application server (SA) and the device (DC) negotiate and save an encryption key (Kc), and exchange messages by means of the management server (SG), at least one of the messages comprising application data (DonA) which is encrypted with the key by at least one of either the device (DC) or the server (SA).

The present invention pertains to managing at least one communication device implementing at least one application using a service offered by an application server over a telecommunications network.

A communication device implementing an application that uses a service offered by an application server over a telecommunications network, contains a set of management data that may be read or modified by an outside entity, such as the application server or a server managed by the operator of the telecommunications network, and which is devoted to operating the application. This management data set comprises, for example, data specific to the application and data related to communication parameters of the device for operating the service over a telecommunications network.

There already exists a system in which multiple management servers are deployed, one management server being deployed by the network's operator to manage data related to communication parameters, and one management server being deployed by the application provider to manage data specific to the application. Each server possesses access control lists and has access to some of the management data set. Such a system has the drawback that the provider must itself deploy a management server.

There is a need for application providers, such as machine-to-machine application providers, to outsource management of at least some of the management data set of a communication device to the operator of the telecommunications network, and in particular to outsource the management of at least some of the data specific to the application.

One goal of the invention is particularly to propose a management system in which data specific to the application exchanged between the device and the application provider over the telecommunications network is not visible to the operator of the telecommunications network or to any other third-party entity that participates in the data exchange.

To achieve this goal, a method for managing at least one communication device implementing an application using a service offered by an application server over a telecommunications network, the communication device comprising application data specific to the application and communication data related to communication parameters for operating the service over the telecommunications network, the communication data being managed by a management server, the method comprising:

a negotiation of an encryption key between the application server and the communication device which each save the negotiated encryption key, and

a message exchange between the application server and the communication device by means of the management server, at least one of the messages comprising application data which is encrypted with the encryption key by at least one of either the communication device or the application server.

Advantageously, the invention proposes a solution to the service provider to outsource the management of the communication devices, the operator of the telecommunications network having no ability to view the data exchanged between the service provider and the communication device. The invention ensures end-to-end encryption of the data specific to the application.

An application provider may thereby accept such outsourcing of the management of a device to the operator of the telecommunications network, because the data specific to the application is opaque to the operator. This application-specific data is, for example, configuration management data, performance data, or alarm data, and the operator of the telecommunications network does not have access to read the content of that data.

Furthermore, the service provider is exempt from owning a management server, as the management server is owned by the operator of the telecommunications network or by another third-party entity and may be used by multiple applications.

In another characteristic of the invention, the method may further comprise the following steps:

transmitting a first request from the application server to the management server,

transmitting a second request from the management server to the communication device depending on the content of the first request,

transmitting a first response from the communication device to the management server, and

transmitting a second response from the management server to the application server depending on the content of the first response,

at least one of the first and second requests and first and second responses comprising application data that is encrypted with the encryption key by at least one of either the communication device or the application server.

According to one embodiment of the invention, the application data may comprise attributes respectively associated with values, and the method may comprise the following steps:

transmitting a first request from the application server to the management server, the first request comprising at least one attribute,

transmitting a second request from the management server to the communication device, the second request comprising at least said attribute,

in the communication device, retrieving a value associated with the attribute comprised within the received second request and encrypting the value with the encryption key,

transmitting a first response from the communication device to the management server, the first response comprising the encrypted value,

transmitting a second response from the management server to the application server, the second response comprising the encrypted value, and

in the application server, decrypting the encrypted value with the encryption key.

According to another embodiment of the invention, the application data may comprise attributes respectively associated with values, and the method may comprise the following steps:

in the application server, encrypting at least one value with the encryption key,

transmitting a first request from the application server to the management server, the first request comprising at least the encrypted value,

transmitting a second request from the management server to the communication device, the second request comprising at least the encrypted value,

in the communication device, decrypting the encrypted value comprised within the received second request with the encryption key, and saving the decrypted value associated with an attribute,

transmitting a first response from the communication device to the management server, the first response comprising an indication that the value has been saved, and

transmitting a second response from the management server to the application server, the second response comprising an indication that the value has been saved.

The invention also pertains to an application server for managing at least one communication device implementing an application using a service offered by the application server over a telecommunications network, the communication device comprising application data specific to the application and communication data related to communication parameters for the operation of the service over the telecommunications network, the communication data being managed by a management server, the application server comprising:

means for negotiating an encryption key with the communication device and means for saving the negotiated encryption key,

means for encrypting and decrypting application data with the encryption key, and

means for exchanging messages with the communication device by way of the management server, at least one of the messages comprising application data which is encrypted with the encryption key by at least one of either the communication device or the application server.

The invention also pertains to a communication device implementing an application using a service offered by the application server over a telecommunications network, the communication device comprising application data specific to the application and communication data related to communication parameters for operating the service over the telecommunications network, the communication data being managed by a management server, the communication device comprising:

means for negotiating an encryption key with the application server and means for saving the negotiated encryption key,

means for encrypting and decrypting application data with the encryption key, and

means for exchanging messages with the application server by way of the management server, at least one of the messages comprising application data which is encrypted with the encryption key by at least one of either the communication device or the application server.

The invention also pertains to computer programs capable of being implemented within a server and within a communication device, said programs comprising instructions which, when the programs are executed within said server and said communication device, carry out steps according to the inventive method.

The present invention and the benefits thereof shall be better understood upon examining the description below, which makes reference to the attached figures, in which:

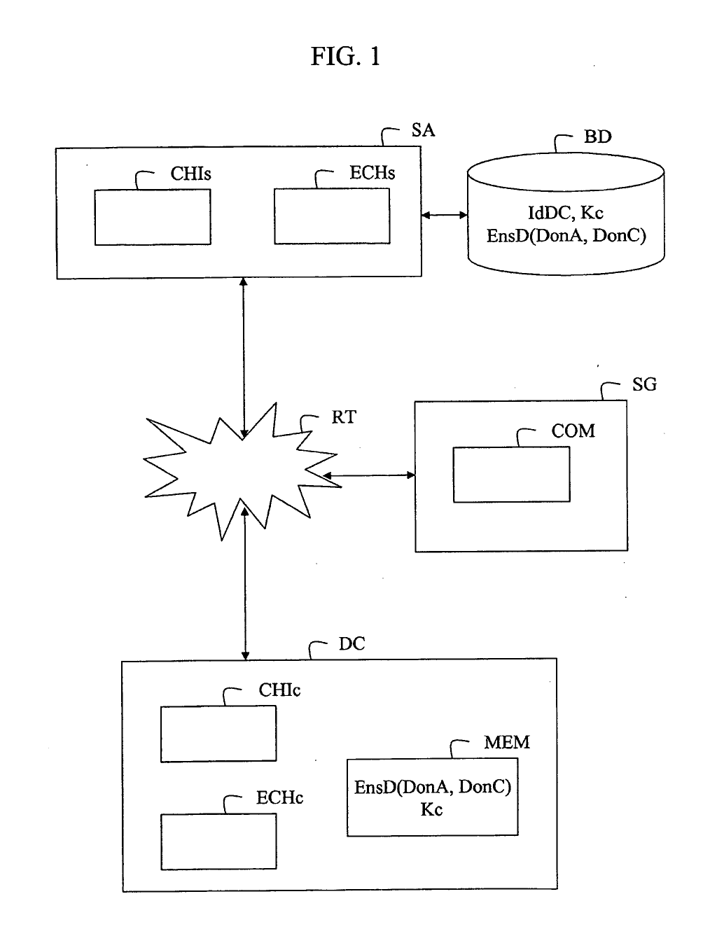

FIG. 1 is a schematic block diagram of a communication system according to one embodiment of the invention,

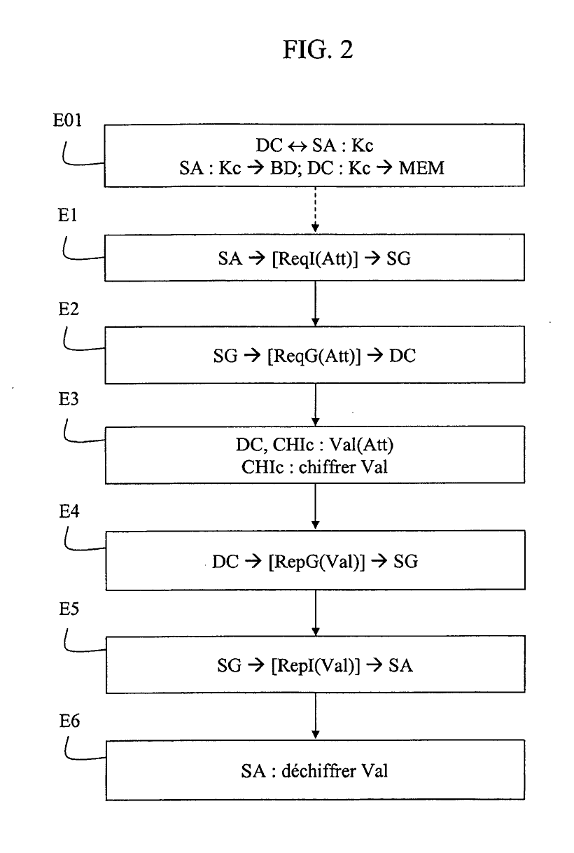

FIG. 2 is an algorithm of a method for managing a communication device according to one embodiment of the invention, and

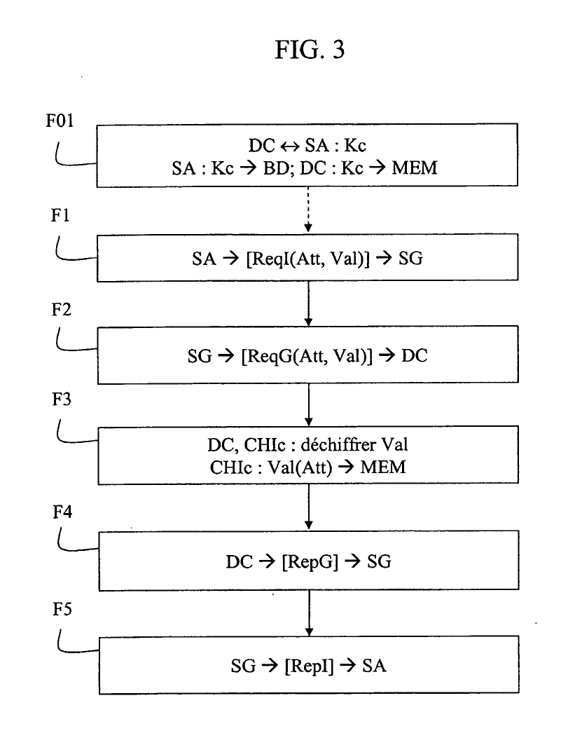

FIG. 3 is an algorithm of a method for managing a communication device according to a second embodiment of the invention.

The invention relates to communication device management from an application server via a management server over a telecommunications network.

In the remainder of the description, an application server is, for example, managed by a company that may potentially possess or have provided the communication device, and the application server may offer one or more digital services accessible from the communication device. A digital service may be a service providing multimedia data, such as digital files comprising text and/or sound and/or an image, for example in order to update digital data managed by the communication device, such as prices of services offered by the service entity. Furthermore, the application server may administer a database containing information related to each of the communication devices belonging to or being operated by the company that manages the application server. A communication device may also inform the application server of the latest changes produced related to the application.

As previously explained, a communication device, implementing an application using a service offered by an application server over a telecommunications network, contains a management data set comprising data specific to the application, as well as data related to communication parameters of the device for operating the service over a telecommunications network. This data set is dedicated to the operation and management of the device, and may be partially managed by various outside entities, such as the application server and a management server administered by the operator of the telecommunications network.

For example, a management server particularly has the functionality of initializing and updating a configuration of a communication device, of retrieving the application's management data, and of processing events or alarms produced by the application. For example, a management server enables an external party to remotely execute a configuration of parameters for a communication protocol between the communication device and the management server, or to install an update of an application's programs.

According to one embodiment of the invention, a management server administered by the operator of the telecommunication network or by a third-party entity must opaquely process the application-specific data exchanged between the communication device and the application server, while processing data related to communication parameters of the communication device for the operation of the service over the telecommunications network.

With reference to FIG. 1, a communication system comprises at least one application server SA, a management server SG, and a communication device DC, capable of communicating with one another over a telecommunications network RT.

It may be assumed that the application server SA and the communication device DC are configured according to a client-server structure in which the application server SA plays the role of a server managing one or more communication devices DC which each play the role of a client. In the remainder of the description, it is considered by way of example that the application server SA is managing a single application implemented within a single communication device.

The telecommunications network RT may be a wireline or wireless network, or a combination of wireline and wireless networks. For example, the telecommunications network RT is a high-speed IP (“Internet Protocol”) packet network, such as the Internet or an intranet.

In one example, a communication device DC is a personal computer connected directly by modem to an xDSL (Digital Subscriber Line) or ISDN (Integrated Services Digital Network) line connected to the telecommunications network RT.

In another example, a communication device DC is a mobile cellular radio communications terminal, connected by a radio communication channel to the telecommunications network, for example a GSM (“Global System for Mobile communications”) or UMTS (“Universal Mobile Telecommunications System”) network.

In another example, a communication device DC comprises a device or electronic telecommunications object which may be a communicating personal digital assistant PDA, or a smartphone, that can be connected to an access terminal of a public short-range wireless local area network WLAN or a network compliant with one of the 802.1x standards, or a medium-range WIMAX (“World wide Interoperability Microwave Access”) wireless local area network connected to the telecommunications network.

In other examples, a communication device DC is a motor vehicle belonging to a taxi company, or an automatic meter of a particular energy, such as water, gas, or electricity belonging to an energy industry company, or a drink vending machine that belongs to a company that specializes in the vending of food products.

The communication device is a fixed or mobile device that may communicate with the application server SA via the telecommunications network RT, to inform the application server of the latest changes produced, such as the mileage of the motor vehicle or the number of drinks remaining in the drink vending machine.

The communication device and the telecommunications network are not limited to the examples above, and may be constituted by other known devices and networks.

The application server SA comprises an encryption module CHIs and an exchange module ECHs.

In the remainder of the description, the term module may designate a device, a software program, or a combination of computer hardware and software, configured to execute at least one particular task.

The application server SA is connected to a database BD, which is integrated into the server SA or incorporated into a database management server connected to the server SA by a local or remote link.

In particular, the database BD saves encryption keys Kc and management data sets EnsD related to communication devices. For example, an identifier IdDC of the communication device is saved as a match with a management data set EnsD and with at least one encryption key Kc.

This management data set EnsD comprises application data DonA specific to the application and communication data DonC related to communication parameters of the device for the operation of the service over a telecommunications network. The application-specific data comprises configuration management data, performance management data, alarm management data, and the application's program data, such as software of the firmware type.

It may be assumed that some data among the application data DonA may correspond to a parameter that is in the form of an attribute with a value. If so, the attribute's value corresponds to the parameters value.

The encryption module CHIs is capable of negotiating with the communication device an encryption key Kc for encrypting and decrypting data. The encryption module CHIs may potentially determine the encryption key and transmit it to the communication device DC. The encryption module CHIs saves the encryption key in the database BD.

In one embodiment, these encryption functionalities are included in a so-called encryption server. For example, the encryption module CHI communicates with that encryption server, which determines an encryption key and transmits that key to the encryption module CHI. The module CHI thereby indirectly determines an encryption key.

The encryption module CHIs encrypts or decrypts application data DonA specific to the application.

The exchange module ECHs is capable of exchanging messages with the communication device DC by means of the management server SG, at least one of the messages comprising application data DonA which is encrypted by the application server SA or by the communication device DC.

The exchange module ECHs is capable of transmitting requests containing encrypted application data DonA to the management server SG, the application data DonA being intended for the communication device DC. The exchange module ECHs may additionally receive responses containing encrypted data from the management server SG, the data having come from the communication device DC.

The management server SG comprises a communication module COM whose functionality is to exchange data transmitted from the application server SA to the communication device DC, and data transmitted from the communication device DC to the application server SA.

The communication module COM particularly interprets requests transmitted from the application server SA and produces other requests intended for the communication device DC depending on the requests received from the application server. Likewise, the communication module COM particularly interprets responses transmitted from the communication device DC and produces other responses intended for the application server SA depending on the requests received from the communication device.

In one example, the management server SG is an autoconfiguration server ACS using a TR 069 protocol defined by the BBF (BroadBand Forum), or a DM (Device Management) protocol defined by the organization OMA (Open Mobile Alliance).

The communication device DC comprises an encryption module CHIc, an exchange module ECHc and a memory MEM.

The exchange module ECHc is capable of exchanging messages with the application server SA by way of the management server SG, at least one of the messages comprising application data DonA which is encrypted by the communication device DC or by the application server SA.

The exchange module ECHc is capable of transmitting responses, containing encrypted data DonA, to the management server SG, the data DonA being intended for the application server SA. The exchange module ECHc may additionally receive requests containing encrypted application data from the management server SG, the encrypted data having come from the application server SA.

The encryption module CHIc is capable of determining an encryption key Kc for encrypting and decrypting data DonA specific to the application. In one embodiment, the encryption modules CHIc and CHIs of the communication device and application server, respectively, perform a key negotiation, so that either the communication device or the application server originates the key negotiation and determines the encryption key. The encryption module CHIc saves the encryption key in the memory MEM.

The memory MEM particularly contains the application using the service offered by the application server SA. The memory MEM additionally contains a management data set EnsD comprising application data DonA specific to the application, and communication data DonC related to communication parameters of the device for the operation of the service over a telecommunications network, in a manner similar to the management data set EnsD saved within the database BD linked to the application server SA. The memory MEM also contains an encryption key Kc, which is used to encrypt and decrypt application data DonA specific to the application.

With reference to FIG. 2, a method for managing a communication device according to the first embodiment of the invention comprises steps E1 to E6 executed within the communication system.

During a preliminary step E01, the communication device DC communicates with the application server SA, for example after the device is powered on while the device is being registered with the telecommunications network, or after a given interval of time if the device is already powered on.

The communication device DC and the application server SA perform a key negotiation to determine an encryption key Kc related to the communication device.

The application server SA for the communication device DC determines at least one encryption key Kc related to the communication device DC. In one variant, the encryption module CHIs communicates with another server that is taking part in the negotiation, determines an encryption key, and transmits that key to the encryption module CHIs.

Once negotiation is complete and the key Kc has been determined, the application server saves the key Kc as a match with an identifier IdDC of the communication device in the database BD, and the communication device DC saves the key Kc in the memory MEM.

During step E1, the application server SA produces an instruction request Reql. The instruction request Reql contains instructions for the management server to request to read data DonA saved within the communication device DC.

As previously indicated, data DonA may correspond to a parameter that is in the form of an attribute Att with a value Val. The instructions contained within the instruction request Reql only designate an attribute Att.

According to a first possibility, the instruction request Reql contains instructions to read the value Val of an attribute Att, with the attribute not being encrypted.

According to a second possibility, the instruction request Reql contains instructions to read the value of an attribute, with the attribute being encrypted. In this case, the encryption module CHIs encrypts the attribute Att with the encryption key Kc.

The application server SA transmits the instruction request Reql containing the attribute Att to the management server SG

During step E2, the management server SG receives the instruction request Reql, and produces a management request ReqG depending on the instructions contained within the instruction request Reql.

According to a first possibility, the attribute is not encrypted and the management request ReqG contains a read request without an encryption indication, for example one of the “GetParameterValue” type, associated with the unencrypted attribute.

According to a second possibility, the attribute is encrypted and the management request ReqG contains a read request with an encryption indication, for example one of the “SecureGetParameterValue” type, associated with the encrypted attribute.

The management server SG transmits the management request ReqG containing the attribute Att to the communication device DC.

During step E3, the communication device DC receives the management request ReqG, via the exchange module ECHc. If the attribute is encrypted, the encryption module CHIc decrypts the encrypted attribute with the encryption key Kc.

The encryption module CHIc retrieves the value Val of the attribute Att from within the data DonA contained within the memory MEM and encrypts the value of the attribute.

During step E4, the communication device DC transmits a management response RepG, containing the encrypted value Val of the attribute Att, to the management server SG.

During step E5, the management server SG receives the management response RepG, and produces an instruction response Repl depending on the content of the management response RepG. The instruction response Repl may have content similar to the content of the management response RepG, the instruction response Repl being adapted to the communication protocol used between the management server and the application server.

The management server SG transmits the instruction response Repl, containing the encrypted value Val of the attribute Att, to the application server SA.

During step E6, the application server SA receives the instruction response Repl and decrypts the value Val of the attribute with the encryption key.

With reference to FIG. 3, a method for managing a communication device according to a second embodiment of the invention comprises steps F1 to F5 executed within the communication system.

During a preliminary step F01, similar to the step E01 the communication device DC communicates with the application server SA.

The communication device DC and the application server SA perform a key negotiation to determine an encryption key Kc related to the communication device. The application server SA for the communication device DC determines at least one encryption key Kc related to the communication device DC. The application server saves the key Kc within the database BD and the communication device DC saves the key Kc within the memory MEM.

During step F1, the application server SA produces an instruction request Reql. The instruction request Reql contains instructions for the management server to request to write data DonA saved within the communication device DC.

As previously indicated, data DonA may correspond to a parameter that is in the form of an attribute with a value. The instructions contained within the request Req designate an attribute and its value.

According to a first alternative, the instruction request Reql contains instructions to read the value of an attribute, with the attribute not being encrypted and the value being encrypted with the encryption key Kc.

According to a second alternative, the instruction request Reql contains instructions to write the value of an attribute, with the attribute and value being encrypted with the encryption key Kc.

The application server SA transmits the instruction request Reql containing the attribute Att and the value Val to the management server SG

During step F2, the management server SG receives the instruction request Reql, and produces a management request ReqG depending on the instructions contained within the instruction request Reql.

Depending on whether the first or second alternative holds true, the attribute is or is not encrypted, and the value Val is encrypted. The management request ReqG contains a write request with an encryption indication, for example one of the “SecureSetParameterValue” type associated with the attribute, which is or is not encrypted, and with the encrypted value.

The management server SG transmits the management request ReqG containing the attribute Att and the value Val to the communication device DC.

During step F3, the communication device DC receives the management request ReqG. The encryption module CHIc decrypts the encrypted value Val with the encryption key Kc, and if the attribute Att is encrypted, the encryption module CHIc also decrypts the encrypted value with the encryption key Kc.

The encryption module CHIc saves the decrypted value Val associated with the attribute Att in the memory MEM and thereby replaces the value that had been present and associated with the attribute Att.

During step F4, the communication device DC transmits a management response RepG to the management server SG, the response comprising, for example, an indication that the write request has indeed been executed, meaning that the value Val has indeed been saved.

During step F5, the management server SG receives the management response RepG, and produces an instruction response Repl, whose content is similar to that of the management response RepG. The management server SG transmits the instruction response Repl to the application server SA, which is informed that the write request has been executed.

According to all the steps E1 to E6, and F1 to F5, it may be considered that the application server SA and the communication device DC exchange messages, such as requests and responses, by means of the management server SG, which receives an instruction request Reql from the application server SA and transmits a management request ReqG to the communication device DC, and also receives a management response RepG from the communication device DC and transmits an instruction response Repl to the application server SA. According to the two embodiments described above, at least one of the messages comprises application data DonA, such as an attribute or a value, which is encrypted with the encryption key Kc by at least one of either the communication device DC or the application server SA.

In one variant, the communication device DC and the application server SA use one key for encrypting attributes and another key for encrypting values.

In another variant, the communication device DC and the application server SA each use a different key, such as asymmetrical keys, to encrypt and decrypt attributes or values.

According to another example implementation, a femtocell base station is deployed by a wireless communication network operator, and a gateway for a packet network is deployed by a high-speed wireline communication network operator. The radio communication service via the base station is provided by the wireless network operator, while the packet communication service is provided by the high-speed communication operator. In this example, the communication device DC is a gateway for a packet network implementing an application for the operation of the femtocell base station, the wireless network operator owns an application server SA and the wireline network operator owns a management server SG.

The wireline network operator may offer the wireless network operator, by way of the management server SG, means of managing a specific part of the application's data opaquely, meaning without the wireline operator being able to read that data.

The invention described here particularly relates to a method, a communication device, and a server for managing the communication device over a telecommunications network. According to one implementation of the invention, the steps of the inventive method are partially determined by the instructions of computer programs, partially incorporated within a server, such as the application server SA, and partially within a device, such as the communication device DC. Each program comprises program instructions, which when said program is loaded and executed within the server, carry out the steps of the inventive method.

Consequently, the invention also applies to a computer program, particularly a computer program on or within an information medium, suitable to implement the invention. This program may use any programming language, and be in the form of source code, object code, or intermediate code between source code and object code, such as in a partially compiled form, or in any other form desirable for implementing the inventive method.

1. A method for managing a communication device that implements an application using a service offered by an application server over a telecommunications network, the communication device comprising application data specific to the application and communication data related to communication parameters for an operation of the service over the telecommunications network, the communication data being managed by a management server, the method comprising the steps of:
negotiating an encryption key between the application server and the communication device which each save the negotiated encryption key, and
exchanging messages between the application server and the communication device by way of the management server, at least one of the messages comprising application data that is encrypted with the encryption key by at least one of either the communication device (DC) or the application server (SA).

2. The method according to claim 1, further comprising the steps of:
transmitting a first request from the application server to the management server,
transmitting a second request from the management server to the communication device (DC) depending on the content of the first request,
transmitting a first response from the communication device to the management server, and
transmitting a second response from the management server to the application server depending on the content of the first response,
at least one of the first and second requests and first and second responses comprising application data that is encrypted with the encryption key by at least one of either the communication device or the application server.

3. The method according to claim 1, wherein the application data comprise attributes respectively associated with values, comprising the steps of:
transmitting a first request from the application server to the management server, the first request comprising at least one attribute,
transmitting a second request from the management server to the communication device, the second request comprising at least said attribute,
in the communication device, retrieving a value associated with the attribute comprised within the received second request and encrypting the value with the encryption key,
transmitting a first response from the communication device to the management server, the first response comprising the encrypted value,
transmitting a second response from the management server to the application server, the second response comprising the encrypted value, and
in the application server, decrypting the value encrypted with the encryption key.

4. The method according to claim 3, wherein the application server encrypts said attribute with the encryption key and the first request transmitted from the application server to the management server and the second request transmitted from the management server to the communication device each comprise at least the encrypted attribute, and according wherein the communication device decrypts the encrypted attribute comprised within the received second request with the encryption key, before retrieving a value associated with the decrypted attribute and encrypting the value with the encryption key.

5. The method according to claim 1, wherein the application data comprise attributes respectively associated with values, comprising the steps of:
in the application server, encrypting at least one value with the encryption key,
transmitting a first request from the application server to the management server, the first request (Regl) comprising at least the encrypted value,
transmitting a second request from the management server to the communication device, the second request comprising at least the encrypted value,
in the communication device, decrypting the encrypted value comprised within the second request received with the encryption key, and saving the decrypted value associated with an attribute,
transmitting a first response from the communication device to the management server, the first response comprising an indication that the value has been saved, and
transmitting a second response from the management server to the application server, the second response comprising an indication that the value has been saved.

6. The method according to claim 5, wherein the application server additionally encrypts an attribute associated with the value encrypted with the encryption key and the first request transmitted from the application server to the management server and the second request transmitted from the management server to the communication device each comprise at least the encrypted attribute and the encrypted value, and wherein the communication device additionally decrypts the encrypted attribute comprised within the second request received with the encryption key, before saving the decrypted value associated with the decrypted attribute.

7. An application server configured to manage at least one communication device that implements an application using a service offered by the application server over a telecommunications network, the communication device comprising application data specific to the application and communication data related to communication parameters for an operation of the service over the telecommunications network, the communication data being managed by a management server, the application server comprises:
means for negotiating an encryption key with the communication device and means for saving the negotiated encryption key,
means for encrypting and decrypting application data with the encryption key, and
means for exchanging messages with the communication device by way of the management server, at least one of the messages comprising application data encrypted with the encryption key by at least one of either the communication device or the application server.

8. A communication device that implements an application using a service offered by an application server over a telecommunications network, the communication device comprising application data specific to the application and communication data related to communication parameters for an operation of the service over the telecommunications network, the communication data being managed by a management server, the communication device comprises:
means for negotiating an encryption key with the communication device and means for saving the negotiated encryption key,
means for encrypting and decrypting application data with the encryption key, and
means (ECHc) for exchanging messages with the application server by way of the management server, at least one of the messages comprising application data encrypted with the encryption key by at least one of either the communication device or the application server.

9. A non-transitory computer-readable storage medium having computer executable instructions for performing steps capable of being implemented in an application server to manage at least one communication device that implements an application using a service offered by the application server over a telecommunications network, the communication device comprising application data specific to the application and communication data related to communication parameters for an operation of the service over the telecommunications network, the communication data being managed by a management server, said program comprising:
negotiating an encryption key with the communication device and saving the negotiated encryption key, and
exchanging messages with the communication device by way of the management server, at least one of the messages comprising application data encrypted with the encryption key by at least one of either the communication device or the application server.

10. A non-transitory computer-readable storage medium having computer executable instructions for performing steps capable of being implemented in a communication device to implement an application using a service offered by an application server over a telecommunications network, the communication device comprising application data specific to the application and communication data related to communication parameters for an operation of the service over the telecommunications network, the communication data being managed by a management server, comprising:
negotiating an encryption key with the application server and saving the negotiated encryption key, and
exchanging messages with the application server by way of the management server, at least one of the messages comprising application data encrypted with the encryption key by at least one of either the communication device or the application server.
